(19) United States
(12) Patent Application Publication
(10) Pub. No.: US 2009/0106734 A1
(43) Pub. Date: Apr. 23, 2009

(54) BAYESIAN BELIEF NETWORK QUERY TOOL

(76) Inventors: Michael J. Riesen, Perrysburg, OH (US); Gursel Serpen, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/256,743

(22) Filed: Oct. 23, 2008

Related U.S. Application Data
(63) Continuation of application No. 61/000,044, filed on Oct. 23, 2007.

(51) Int. Cl. G06F 7/06; G06F 17/30; G06F 9/44

(52) U.S. Cl. 717/104; 707/3; 707/E17.014

(57) ABSTRACT

A dataset query tool is disclosed, the query tool including a dataset having a plurality of attributes, wherein each of the attributes has one of a plurality of potential values, a processor adapted to develop a model of the dataset and calculate a posterior probability of at least one of the attributes of the dataset, wherein the model represents an approximation of the joint probability distribution of the dataset, a user interface in communication with the processor, wherein the user interface provides a means for a user to selectively identify values for at least one of the attributes of the dataset and selectively query at least one of the other attributes for a posterior probability calculation based on the identified values.

### CROSS-REFERENCE TO RELATED APPLICATION

This application claims the benefit of U.S. provisional patent application Ser. No. 61/000,044 filed Oct. 23, 2007, hereby incorporated herein by reference in its entirety.

### FIELD OF THE INVENTION

The invention relates to a method and tool for modeling datasets. More particularly, the invention is directed to a dataset query tool and a method for querying a large dataset.

### BACKGROUND OF THE INVENTION

Bayesian Belief Networks can be a model of any dataset such as a weather dataset, a disease and its symptoms dataset, a military dataset, and a criminal incident dataset, for example. Bayesian belief networks are especially useful when the information about the past and/or the current situation is vague, incomplete, conflicting, and uncertain. Typically, Bayesian belief networks are models in which each variable or attribute of the dataset is represented by a node, and causal relationships are denoted by an arrow, called an edge or arc. Nodes can represent any kind of variable, be it a measured parameter, a latent variable or a hypothesis. Efficient algorithms exist that perform inference and learning in Bayesian networks. Bayesian networks that model sequences of variables (such as for example speech signals or protein sequences) are called dynamic Bayesian networks. Generalizations of Bayesian networks that can represent and solve decision problems under uncertainty are called influence diagrams.

Despite the recent pioneering work in the research and application of Bayesian networks, it is clear that the general public remains generally uninformed and inexperienced with respect to Bayesian reasoning. Accordingly, there is a need to further expose the knowledge that is potentially hidden and embedded within datasets beyond the basic statistical presentation offered by published and online literature.

Currently, various software packages enable a user to build a Bayesian Belief Network (BBN) for modeling a particular dataset. However, software applications such as the WEKA® software (an open source software from the University of Waikato) are limited to the extent that a BBN model based on a class attribute within the WEKA® software may only be queried for the class attribute.

It would be desirable to develop a dataset query tool and a method for querying a dataset, wherein the dataset query tool and method provide a simple means for a user to determine a posterior belief of any attribute of the dataset.

### SUMMARY OF THE INVENTION

Concordant and consistent with the present invention, a dataset query tool and a method for querying a dataset, wherein the dataset query tool and method provide a simple means for a user to determine a posterior belief of any attribute of the dataset, has surprisingly been discovered.

In one embodiment, a dataset query tool comprises: a dataset having a plurality of attributes, wherein each of the attributes has one of a plurality of potential values; a processor adapted to receive the dataset, develop a model of the dataset, and calculate a posterior probability of at least one of the attributes of the dataset, wherein the model represents an approximation of the joint probability distribution of the dataset; and a user interface in communication with the processor, wherein the user interface provides a means for a user to selectively identify values for at least one of the attributes of the dataset and selectively query at least one of the other attributes for a posterior probability calculation based on the identified values.

The invention also provides methods for querying a dataset.

One method comprises the steps of: providing a dataset having a plurality of attributes, wherein each of the attributes has one of a plurality of potential values; developing a model to represent an approximation of the joint probability distribution of the dataset; identifying an evidence; querying a focus attribute of the dataset to determine a posterior probability of the focus attribute based on the identified evidence.

Another method comprises the steps of: providing a model to represent an approximation of the joint probability distribution of a dataset; providing a user interface for interacting with the model; providing values for a subset of the attributes represented in the model; querying a focus attribute of the dataset to determine a posterior probability of the focus attribute based on the provided values for the subset of the attributes.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a dataset query tool according to an embodiment of the present invention;

FIG. 2 is a flow diagram of a method for querying a dataset according to an embodiment of the present invention; and

FIG. 3 is a flow diagram of a method for building a Bayesian Belief Network according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

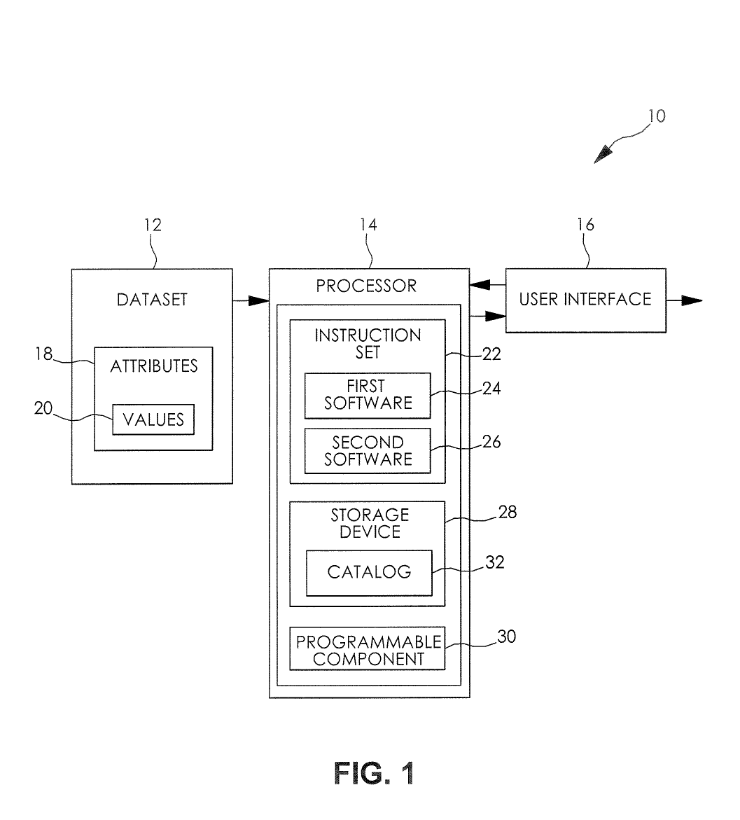

FIG. 1 illustrates a dataset query tool 10 according to an embodiment of the present invention. As shown, the dataset query tool 10 includes a dataset 12, a processor 14, and a user interface 16. It is understood that the dataset query tool 10 may include additional components, as desired.

The dataset 12 may be any collection of information having a plurality of attributes 18 or variables, wherein each of the attributes 18 has a plurality of potential values 20. In one embodiment, the dataset 12 is the U.S. Dept. of Justice, Bureau of Justice Statistics, NATIONAL CRIME VICTIMIZATION SURVEY(NCVS): MSA DATA, 1979-2004 incident-based dataset including attributes related to incidents of crime. For example, the NCVS MSA dataset includes attributes describing characteristics of the victim, characteristics of the offender, and characteristics of the criminal incident. However, is understood that other datasets may be used.

In certain embodiments, the processor 14 is a micro-computer adapted to receive the dataset 12 and analyze the dataset 12 based upon an instruction set 22. The instruction set 22, which may be embodied within any computer readable medium, includes processor executable instructions for configuring the processor 14 to perform a variety of tasks. In certain embodiments, the instruction set 22 includes a first software code 24 and a second software code 26, wherein each of the first and second software codes 24, 26 is coded to control particular functions of the processor 14. It is understood that the processor 14 may be adapted to import and export information such as the dataset 12. It is further understood that the processor 14 may be in communication with other processors, networks and systems.

The processor 14 may also include a storage device 28. The storage device 28 may be a single storage device or may be multiple storage devices. Furthermore, the storage device 28 may be a solid state storage system, a magnetic storage system, an optical storage system or any other suitable storage system or device. It is understood that the storage device 28 is adapted to store the instruction set 22. Other data and information may be stored in the storage device 28 such as user information, pre-developed models of various datasets, and software code for interacting with the user interface and other devices, for example.

The processor 14 may further include a programmable component 30. In certain embodiments, the programmable component 30 is adapted to manage and control processing functions of the processor 14. Specifically, the programmable component 30 is adapted to control the analysis of the dataset 12. It is understood that the programmable component 30 may be adapted to manage the functions of the user interface 16. It is further understood that the programmable component 30 may be adapted to store data and information in, and retrieve data and information from, the storage device 28.

The user interface 16 is an interface for providing control of the functions of the processor 14 to a user. Specifically, the user interface 16 is in communication with the processor 14 and is adapted to send and receive data and information therebetween. In certain embodiments, the user interface 16 is a graphical user interface, wherein the user may control the functions of the processor 14 through a web-based application. As such, the processor 14 is adapted to transmit feedback to the user via the user interface 16. Other interfaces and applications may be used such as a software package, a software add-on, and a stand-alone device, for example.

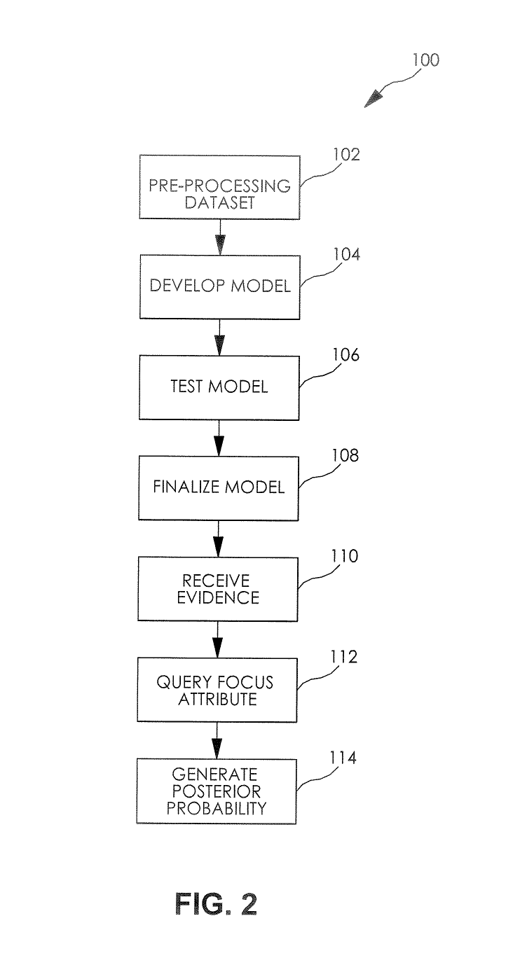

FIG. 2 illustrates a method 100 for querying the dataset 12 to generate a posterior probability based upon an evidence supplied by the user. In step 102, the dataset 12 is pre-processed. Specifically, once the dataset 12 is identified, e.g. the NCVS MSA, the discrete values 20 of each attribute 18 may be converted to pre-determined formats for analysis by the processor 14. Additionally, certain sub-classifications of the attributes 18 may be modified or eliminated to limit redundancy and processing bugs. For example, where one attribute 18 represents a victim's date of birth and another attribute 18 represents a victim's age, the date of birth may be removed to produce a more accurate model.

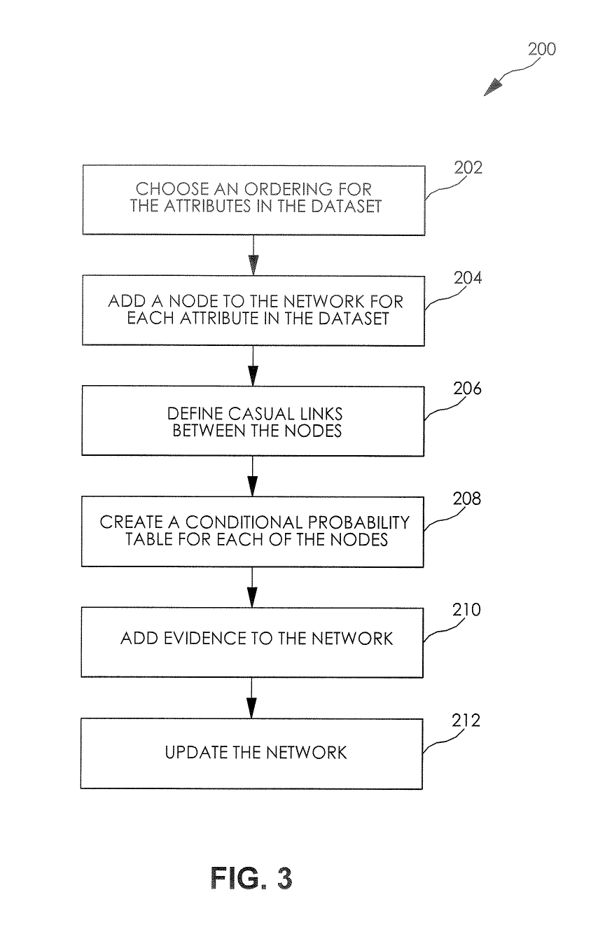

In step 104, the processor 14 builds a model of the dataset 12. In certain embodiments, a Bayesian Belief Network (BBN) is built to model the dataset 12. As more clearly shown in FIG. 3, the BBN may be built using a sub-routine 200. In step 202 a user-defined ordering of the attributes 18 is provided. In step 204, each attribute 18 in the dataset 12 is assigned a node. In step 206, using expert opinions and prior knowledge, causal links between a parent and a child node are defined. Where no conditional independence exists, no link is associated between the independent nodes. In step 208, once the causal links are defined, a conditional probability table (CPT) for each of the nodes is computed. It is understood that the conditional independence relationships will determine the complexity of the CPT for each of the nodes. Once the CPTs are defined for each of the nodes, queries may be posed on the network. However, if there is more evidence (i.e. data), the process continues and the causal links and CPTs are updated to accommodate the new information, as shown in steps 210 and 212.

In certain embodiments, the first software 24 may be implemented to build the model of the dataset 12, according to step 104. As a non-limiting example, the first software 24 may be coded in a similar fashion as the WEKA® software to develop the BBN model of the dataset 12. Exemplary results were achieved using the BayesNet classifier algorithm, known in the art. It is understood that various structure and parameter learning algorithms may be used to develop the BBN model such as local score based structure learning (i.e. MDL based), conditional independence based structure learning, and global score based structure learning (i.e. cross validation based), for example. It is further understood that empirical experimentation with the parameters of each of the learning algorithms provides an optimized learning algorithm for any particular dataset. As a non-limiting example, satisfactory results for the NCVS MSA incident-based dataset were obtained from a BBN classifier model generated through the “Local K2-P4-N-S BAYES” option for the K2 local score based structure learning algorithm having a predetermined class attribute. As such, the BBN classifier model is a reasonably accurate approximation of the full joint probability distribution. However, other algorithms, class attributes, and settings may be used, as desired.

In step 106, the model of the dataset 12 is tested for accuracy by sampling a pre-determined subset of the dataset 12 and testing the values 20 of the attributes 18 in the sample against the full model of the dataset 12. It is understood that other forms of cross-validation and train-testing splits may be used, as is known to someone skilled in the art of data modeling.

In step 108, the model is finalized and the complete BBN model is embedded with the conditional probability tables for each of the attributes 18 (nodes) and a representation of the causal links (arcs). It is understood that the BBN model includes the conditional probability table (CPT) and identified causal relationships for each of the attributes 18 of the dataset 12. It is further understood that the BBN model may be stored and exported as a single file for transfer and for use with alternative applications.

As a non-limiting example, a catalog 32 or index of finalized BBN models representing various datasets 12 may be stored and subsequently accessed by the user. Specifically, the user interface 16 may be adapted to provide a selective access to the catalog 32 of models. As such, the user simply selects a BBN model for a particular dataset 12 and proceeds to steps 110 and 112.

In steps 110 and 112, the processor 12 receives user-provided input from the user interface 16. Specifically, in step 110, the user assigns values 20 to a user-selected subset of the attributes 18 or variables of the dataset 12, which forms the so-called evidence. In step 112, the user queries a user-selected focus attribute to determine the posterior marginal probability or expectation of the focus attribute given the evidence.

In certain embodiments, the second software 26 may be implemented to compute at least one of a marginal probability for any of the attributes 18 in the BBN model of the dataset 12, expectations for uni-variate functions, i.e., the expected value of a random variable, and configurations with maximum a posteriori probability.

As a non-limiting example, the second software 26 may include code similar to the JavaBayes software package, an open source software available at the website http://www.cs.cmu.edu/javabayes/. As such, the user assigns values to a subset of attributes 18 and poses a query to the processor 14 to determine the posterior marginal probability or expectation of some other one of the attributes 18. The second software 26 is adapted to calculate marginal probabilities and expectations that are conditional on any number of evidence values 20 supplied to the processor 14. The user may pose a query by specifying some evidence and querying for a set of values 20 of non-evidence attributes 18 that would result in a maximum posterior probability for that evidence. It is understood that not only is it possible to specify a sub-group of the attributes 18 for estimation, the processor 14 can also estimate all of the attributes 18 at once. It is further understood that other software codes, algorithms and applications may be used, as desired.

In step 114, a posterior probability for the user-defined focus attribute is provided to the user in response to the user-provided evidence. As an example, the BBN model of the NCVS MSA incident-based dataset may include 259 nodes representing the 259 attributes of the dataset. As such, it is possible to explore the posterior probabilities of any of the attributes 18 contained in the NCVS MSA incident-based dataset. The user simply supplies prior evidence and, with a press of a button (embedded in the user interface 16), the processor 14 calculates the posterior probability of the selected attribute 18, given the prior evidence. In fact, any number of values 20 and attributes 18 can be supplied by the user as evidence. As an illustrative example, consider the following ‘Hypothetical Victim’ profile: Single (NCVS variable V3015=5); 18-24 year old (NCVS variable V3014=2); White (NCVS variable V3023=1); Female (NCVS variable V3018=2); Attending college (NCVS variable V3020=40); Living in Philadelphia (NCVS variable MSACC=26). By selecting each of the NCVS variables associated with the “Hypothetical Victim” profile and assigning the value 20 associated with the profile characteristics, the user can effortlessly query the probability that this ‘Hypothetical Victim’ will report to police an incident where she is a victim of attempted or completed rape. Specifically, the user supplies the values 20 for each of the evidence attributes 18 and then selects the “report to police” attribute (NCVS V4399) to be queried. Implementing the BBN model developed in the method 100 for querying the dataset 12, the processor 14 calculates the posterior probability that the “Hypothetical Victim” would report the incident of attempted or completed rape to the police. Thereafter, the processor 14 exports the posterior probability back to the user interface 16.

A further illustrative example will be leveraged to demonstrate the multiple evidence based query formulation and subsequent queries to the BBN model of the NCVS MSA incident dataset. Accordingly, let the following scenario hold true: “A parent is sending her child to Chicago to go to college. The parent would like to know if her daughter should live in a single unit home or an apartment with ten or more units.”

The hypothetical question can be converted into a query through the following set of the attributes 18 and the associated values 20: NCVS attribute MSACC representing an MSA Core County is set to a value of 6, representing “Chicago, Ill.”; NCVS attribute V3018, representing the Victim's gender, is set to 2, representing “Female”; NCVS attribute V3014, representing the Victim's Age is set to 2, representing “18-24 years old”; NCVS attribute V2024, representing a Number of Housing Units in residence structure, is set to 1, representing “a single unit” or 6, representing ten or more units. Accordingly, a query of the NCVS “Type of Crime” attribute (V4529) can be formulated for the single unit case (V2024=1) and a second query can be developed for the multi-unit housing scenario (V2024=6). As such, the posterior probability values are computed by the processor 14 in light of the BBN model and the results of the first query and the second query are exported to the user for comparison.

In certain embodiments, a rule-generating algorithm may be used to produce a plurality of automatically-generated queries to be posed to the processor 14. Specifically, an algorithm similar to the PART rule mining algorithm, known in the art, may be applied to the BBN model of the dataset 12 to generate a list of IF-THEN rules. As such, assuming the values 20 of the attributes 18 represented by an IF-premise of the generated rules are true, the posterior probability of the THEN consequent of the rule will be highly probable. Each of the rules generated by the PART algorithm readily lends itself to the query formation, wherein the IF-premise becomes the prior evidence for a query where the posterior probability value calculation is desired for the THEN consequent. Such queries may be employed to validate the BBN model of the full joint probability distribution of the attributes 18 in the dataset 12.

The dataset query tool 10 and the method 100 provide a generic software-based application for users to probe any set of the attributes 18 included in the dataset 12 for (posterior) likelihood calculations. The user needs only a basic appreciation of the concept of probability, and no additional mathematical sophistication is required. Further, the rule-generation component provides an automatically generated query set for implementation by the user.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A dataset query tool comprising:
a dataset having a plurality of attributes, wherein each of the attributes has one of a plurality of potential values;
a processor adapted to receive the dataset, develop a model of the dataset, and calculate a posterior probability of at least one of the attributes of the dataset, wherein the model represents an approximation of the joint probability distribution of the dataset; and
a user interface in communication with the processor, wherein the user interface provides a means for a user to selectively identify values for at least one of the attributes of the dataset and selectively query at least one of the other attributes for a posterior probability calculation based on the identified values.

2. The dataset query tool according to claim 1, wherein the dataset is at least one of a victimization dataset, a criminal profiling dataset, and a crime incident-based dataset.

3. The dataset query tool according to claim 1, wherein the processor includes at least one of a first software code for developing a model of the dataset and a second software code for calculating the posterior probability of at least one of the attributes based on the indentified values.

4. The dataset query tool according to claim 1, wherein the model is a Bayesian Belief Network.

5. The dataset query tool according to claim 1, wherein the user interface is a graphical user interface.

6. The dataset query tool according to claim 1, wherein the user interface is a web application.

7. The dataset query tool according to claim 1, wherein the processor includes a storage device for storing a catalog of pre-generated models to be accessed and queried.

8. A method for querying a dataset, the method comprising the steps of:
providing a dataset having a plurality of attributes, wherein each of the attribute has one of a plurality of potential values;
developing a model to represent an approximation of the joint probability distribution of the dataset;
identifying an evidence;
querying a focus attribute of the dataset to determine a posterior probability of the focus attribute based on the identified evidence.

9. The method according to claim 8, wherein the dataset is at least one of a victimization dataset, a criminal profiling dataset, and a crime incident-based dataset.

10. The method according to claim 8, further comprising the step of providing at least one of a first software code for developing a model of the dataset and a second software code for calculating the posterior probability of at least one of the attributes based on the evidence.

11. The method according to claim 8, wherein the model is a Bayesian Belief Network.

12. The method according to claim 8, further comprising the step of providing a user interface for interacting with the model.

13. The method according to claim 12, wherein the user interface is a graphical user interface.

14. The method according to claim 12, wherein the user interface is a web application.

15. The method according to claim 8, further comprising the step of providing a storage device for storing a catalog of pre-developed models to be accessed and queried.

16. The method according to claim 8, further comprising the step of implementing a rule-generation algorithm to generate a list of potential queries.

17. A method for querying a dataset, the method comprising the steps of:
providing a model representing an approximation of the joint probability distribution of a dataset;
providing a user interface for interacting with the model;
providing values for a subset of the attributes represented in the model;
querying a focus attribute of the dataset to determine a posterior probability of the focus attribute based on the provided values for the subset of the attributes.

18. The method according to claim 8, wherein the model is a Bayesian Belief Network.

19. The method according to claim 12, wherein the user interface is a web application.

20. The method according to claim 8, further comprising the step of implementing a rule-generation algorithm to generate a list of potential queries.
